(19) United States
(12) Patent Application Publication
(10) Pub. No.: US 2012/0124238 A1
(43) Pub. Date: May 17, 2012

(54) PRIORITIZATION OF ROUTING INFORMATION UPDATES

(75) Inventors: Thyaga NANDAGOPAL, Edison, NJ (US); Kiran M. REGE, Marlboro, NJ (US); Thomas WOO, Short Hills, NJ (US); Wim HENDERICKX, Westerlo (BE)

(73) Assignees: ALCATEL-LUCENT BELL N.V., Antwerp (BE); ALCATEL-LUCENT USA INC., Murray Hill, NJ (US)

(21) Appl. No.: 12/944,900

(22) Filed: Nov. 12, 2010

(51) Int. Cl. G06F 15/173

(52) U.S. Cl. 709/242

(57) ABSTRACT

Various exemplary embodiments relate to a method and related network node including one or more of the following: receiving, at the node, a network state update message; updating a first portion of a first set of routing information based on the network state update message; after updating the first portion of the first set of routing information, beginning an update of a second set of routing information; and after beginning the update of the second set of routing information, updating a second portion of the first set. In various alternative embodiments, the step of updating the first portion includes one or more of the following: determining at least one other node within the network for which routing information should be used to update the second set of routing information; and updating routing information associated with the at least one other node in the first set of routing information.

### TECHNICAL FIELD

Various exemplary embodiments disclosed herein relate generally to network traffic routing.

### BACKGROUND

Packet-switched networks are used to provide an ever-increasing amount of today's varied forms of communication. In addition to computer-to-computer communication via networks such as the Internet, packet-switched networks enable the communication of information associated with other applications such as television, telephone, and radio. Through these and other applications, end users may transmit and receive a multitude of information types over great distances.

In order to move such information from its source to its destination, packet-switched networks employ a number of interconnected routing devices. When one router receives a packet of data, the router will determine where the packet's destination is located and forward the packet to the next closest router. This next router will follow a similar procedure and, in this manner, the packet will eventually be delivered to its destination, much like a “bucket brigade.”

One significant problem in packet switched networks is providing each network with the information necessary to make the determination of which “next hop” router to which each packet should be transmitted. While, in theory, this information could be manually programmed into the router, the size and dynamic nature of network topologies usually render this method impracticable. Instead, various protocols have been developed for automatically determining the best path to each destination for each router. For example, the Open Shortest Path First standard provides for routers within an autonomous system to share information regarding the state of links within the system. Using this information, each router can independently develop a forwarding table for use in determining where each received packet should be sent. When the network state changes, each router updates its forwarding table to ensure that each destination remains reachable and that each path chosen is optimal.

### SUMMARY

While standards such as Open Shortest Path First provide a working solution to the problem of generating routing information, these standards take time to work. For example, immediately after a network change occurs, the routing information at each node is, to some extent, out of date and incorrect. The information will remain outdated until each node receives an indication of the change, determines the new state of the network, determines the optimal routing paths, and updates the forwarding table. With the potential frequency of nodes being added to the network, nodes being removed from the network, nodes entering a faulty state, nodes recovering from a faulty state, and other network changing events, a considerable portion of a router's operating time may be spent either forwarding traffic according to outdated routing information or waiting for up-to-date routing information.

The step of updating the forwarding table may introduce a particularly large delay in updating routing information. In addition to routing information associated with other nodes within the autonomous system, each table may include thousands of entries for other nodes and/or subnets outside of the autonomous system that must be updated in response to a change in the network. Various other routing protocols, however, may depend on an up-to-date forwarding table in order to update other routing information. For example, multi-protocol-label-switching (MPLS) related protocols such as label distribution protocol (LDP) or resource reservation protocol-traffic engineering (RSVP-TE) may use the routes in the forwarding table to establish MPLS paths. As a further example, layer 2 tunneling protocol (L2TP) may also use the forwarding table in a similar fashion.

Accordingly, there is a need for a method of reducing the amount of time between a network-changing event and convergence of network routing information among multiple routing protocols. In particular, it would be desirable to provide a method and network node that reduces the amount of time spent updating routing information for one protocol before another protocol may begin updating other routing information.

In light of the present need for a method of reducing network convergence time, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in the later sections.

Various exemplary embodiments provide a network router that prioritizes updates to particular forwarding table entries. Once such critical updates are performed, other routing information may be updated according to other protocols, while the remaining forwarding table updates are performed. In various exemplary embodiments, routing information for nodes within an OSPF autonomous system may be prioritized such that the information may be used to update MPLS paths while the remaining updates to the forwarding table are applied.

Various exemplary embodiments relate to a method and related network node including one or more of the following: receiving, at the node, a network state update message; updating a first portion of a first set of routing information based on the network state update message; after updating the first portion of the first set of routing information, beginning an update of a second set of routing information; and after beginning the update of the second set of routing information, updating a second portion of the first set. In various alternative embodiments, the step of updating the first portion includes one or more of the following: determining at least one other node within the network for which routing information should be used to update the second set of routing information; and updating routing information associated with the at least one other node in the first set of routing information.

Various exemplary embodiments relate to a network node including one or more of the following: a first interface that receives a packet from another node; a network state update message identifier that determines that the packet is a network state update message; a first routing information storage that stores a first set of routing information; a second routing information storage that stores a second set of routing information; a first routing information generator that updates a first portion of the first set of routing information based on the network state update message, after updating the first portion, indicates that the first portion has been updated, and after indicating that the first portion has been updated, updates a second portion of the first set of routing information based on the network state update message; and a second routing information generator that, in response to the indication that the first portion has been updated, updates the second routing information based on the first portion of the first set of routing information.

It should be apparent that, in this manner, various exemplary embodiments enable reduction of network convergence time. In particular, by selectively updating certain routing information first and triggering a secondary routing information generator, a network node can reduce the time it takes for all nodes in the network to converge to a common routing state.

### BRIEF DESCRIPTION OF THE DRAWINGS

In order to better understand various exemplary embodiments, reference is made to the accompanying drawings, wherein:

FIG. 1 illustrates an exemplary network for routing data packets;

FIG. 2 illustrates an exemplary shortest path tree for determining the optimal path from one node to a number of other possible nodes;

FIG. 3 illustrates an exemplary forwarding table for determining a next hop to which a packet should be transmitted based on the packet destination;

FIG. 4 illustrates an exemplary network node for routing packets and reducing network convergence time for multiple sets of routing information;

FIG. 5 illustrates an exemplary method for reducing network convergence time for multiple sets of routing information; and

FIG. 6 illustrates an alternative method for reducing network convergence time for multiple sets of routing information.

### DETAILED DESCRIPTION

Referring now to the drawings, in which like numerals refer to like components or steps, there are disclosed broad aspects of various exemplary embodiments. As used herein, the term “routing information” generally refers to any data and/or data structures useful for routing packets including, but not limited to, shortest path trees, forwarding tables, routing tables, MPLS paths, and/or L2TP paths.

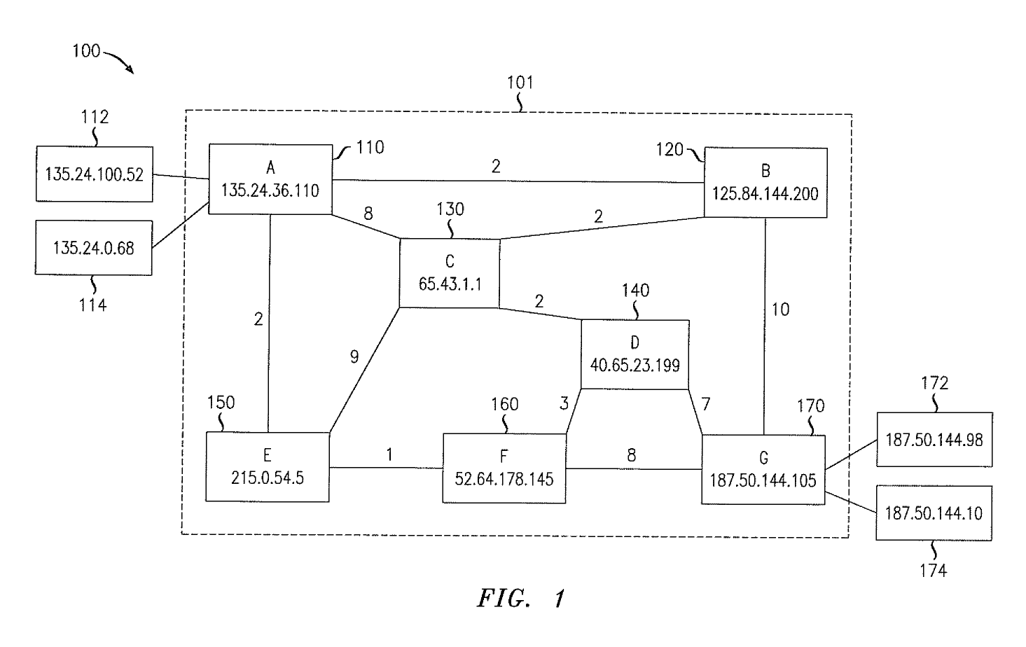

FIG. 1 illustrates an exemplary network 100 for routing data packets. Exemplary network 100 may be a packet-switched communications network for providing data transfer for various applications. Exemplary network 100 may further implement a standard for automatic updating of routing information in response to changes within the network. For example, grouping 101 may constitute an autonomous system implementing the Open Shortest Path First (OSPF) standard.

Exemplary network may include a number of nodes A-G 110-170. Each node A-G 110-170 may be a router, switch, or other network equipment adapted to receive and forward data packets toward the packets' respective destinations. Each node A-G 110-170 may further be associated with one or more network address such as an Internet protocol (IP) address and/or media access controller (MAC) address. While each port of each node may be associated with independent addresses, each node in exemplary network 100 is shown as associated with a single address for the sake of simplicity. One or more nodes A-G 110-170 may also be label-switched routers implementing various protocols such as, for example, multi-protocol label switching (MPLS), label distribution protocol (LDP), resource reservation protocol-traffic engineering (RSVP-TE), and/or layer 2 tunneling protocol (L2TP).

Each node may also be connected to a number of additional devices such as additional network devices and end user equipment. For example, node A 110 is connected to at least two other devices 112, 114, each associated with one or more network address. In various embodiments, devices 112, 114 may belong to similar subnets. For example, devices 112, 114 may both belong to a subnet identified by the IP prefix 135.24.0.0/16. Likewise, node G 170 may be connected to at least two other devices 172, 174 which may belong to the 187.50.144.0/24 subnet. Each node A-G 110-170 may be similarly connected to numerous other devices (not shown).

Nodes A-G 110-170 may each be connected to one or more other nodes A-G 110-170 via one or more links. Each link may be associated with a link cost. For example, node C 130 may be connected to node D 140 via a link having cost 2. This link cost may be assigned based on various factors such as, for example, the geographic distance between the nodes, the number of intermediate devices between the nodes, the bit-rate associated with the link, and/or the current load on the link. Some links, such as the link between node B 120 and node G 170 may be faulty and thus undesirable for forwarding packets. Such links may accordingly be assigned a very high or infinite link cost to discourage use.

Each node A-G 110-170 may store a local representation of exemplary network 100. Such a local representation may be constructed locally from information conveyed in link state advertisement (LSA) messages transmitted by other nodes A-G 110-170 according to OSPF. For example, each node may store an indication of all nodes and edges in a Link State Database (LSDB). Such a representation may be used by each node A-G 110-170 to construct a shortest path tree and, ultimately, a forwarding table for use in forwarding packets to their destination.

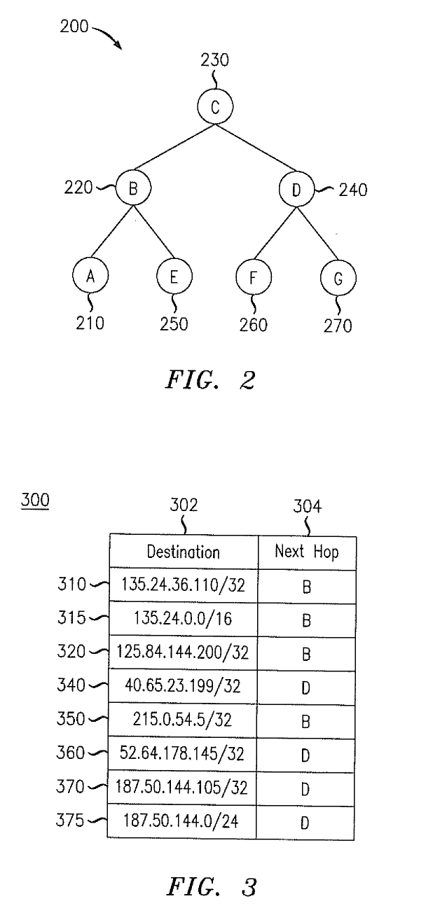

FIG. 2 illustrates an exemplary shortest path tree (SPT) 200 for determining the optimal path from one node to a number of other possible nodes. SPT 200 may be constructed from the perspective of node C 130 using a representation of the current state of the network, such as exemplary network 100, using any method known to those of skill in the art. For example, a node may use Djikstra's Shortest Path Tree algorithm to construct an SPT.

SPT 200 may be an SPT constructed by node C 130 in view of exemplary network 100. SPT 200 may include a number of node representations A-G 210-270 corresponding to nodes A-G 110-170. SPT 200 may indicate the optimal path to each node within the network from node C 130. For example, SPT 200 indicates that the shortest path from node C 130 to node G 170 is through node D 140, rather than through node B 120 or some other path. Accordingly, packets received by node C 130 destined for node G 170 should be forwarded to node D 140, according to SPT 200. Node D 140, in turn, may include its own routing information enabling it to forward the packet to node G 170.

After computing SPT 200, node C 130 may update its forwarding table to reflect the state of exemplary network 100. In particular, node C 130 may analyze SPT 200 to determine the next hop node that should be used for each potential destination node. This information may then be stored in a forwarding table for quick access when forwarding packets.

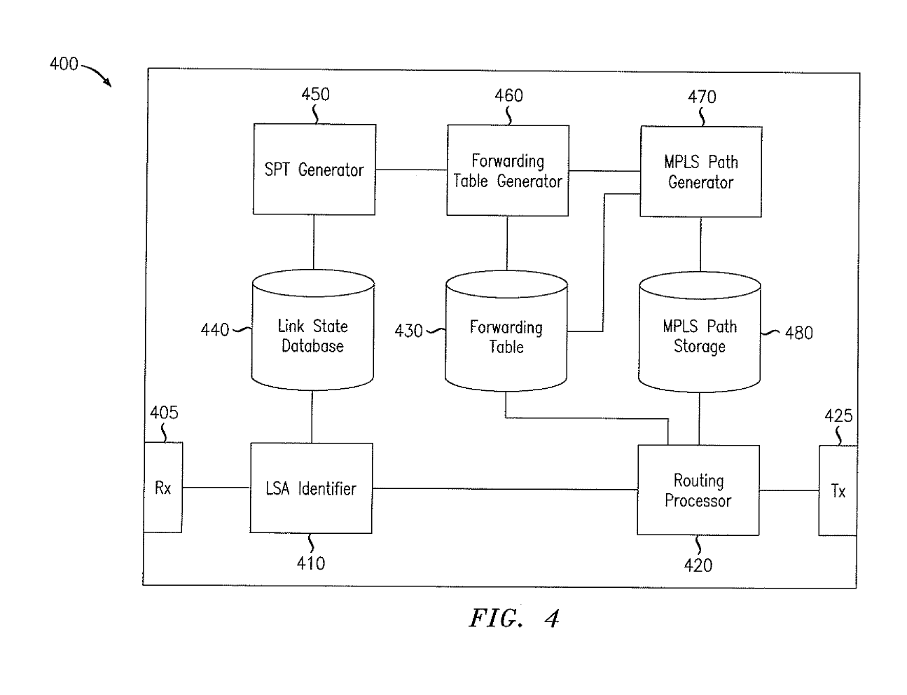

FIG. 3 illustrates an exemplary forwarding table 300 for determining a next hop to which a packet should be transmitted based on the packet destination. Forwarding table 300 may be, for example, a table in a database stored at node C 130. Alternatively, forwarding table 300 could be a series of linked lists, an array, or a similar data structure. Thus, it should be apparent that forwarding table 300 is an abstraction of the underlying data; any data structure suitable for storage of the underlying data may be used.

Forwarding table 300 may include a destination field 302 and a next hop field 304. Destination field 302 may indicate a destination device with which each entry is associated while next hop field 304 may indicate which next hop device is appropriate for the associated destination device. It should be apparent that forwarding table 300 is, in some respects, a simplification. For example, forwarding table may contain additional fields such as an outgoing port number, a destination MAC address, and/or an alternate next hop. Various modifications will be apparent to those of skill in the art.

Forwarding table may include a number of entries 310-370. Entry 310 may indicate that packets destined for the IP address 135.24.36.110 should be forwarded to node B 120. Subnets or other groupings may also be used in destination field instead of full addresses. For example, entry 315 may indicate that packets destined for the 135.24.0.0/16 subnet should also be forwarded to node B 120. Using this entry, packets destined for either device 112 or device 114 may be properly routed. Additional entries 320-375 may indicate next hop routers for each device in exemplary network 100. Table 300 may contain numerous additional entries (not shown) providing routing information for additional nodes and/or subnets.

Having described the components of exemplary network 100, a brief summary of the operation of exemplary network 100 will be provided. It should be apparent that the following description is intended to provide an overview of the operation of exemplary network 100 and is therefore a simplification in some respects. The detailed operation of exemplary network 100 will be described in further detail below in connection with FIGS. 4-6.

Node C 130 may receive an LSA indicating a change in the network. For example, the LSA may indicate that the link between node A 110 and node B 120 is down. Node C 130 may then compute a new SPT, providing the new optimal path for reaching node A 110. Node C 130 may then begin to update its forwarding table 300.

In updating forwarding table 300, node C 130 may prioritize certain updates. For example, node C 130 may first update entries 320, 340 because they are associated with neighboring nodes. Node C 130 may then proceed to update entries 310, 350, 360, 370, after which the forwarding table will be up-to-date with regard to nodes within group 101. Finally, node C 130 may update entries 315, 375 to provide paths to devices outside of group 101.

At some point before node C 130 finishes updating forwarding table 300, node C may also begin updating a second set of routing information such as, for example, MPLS paths or L2TP paths. Node C 130 may begin this secondary update process, for example, after only entries 320, 340 have been updated or after entries for all nodes within group 101 have been updated. The secondary update process may make use of the updated information in table 300. Thus, portions of the routing information update process may be performed in parallel, reducing the amount of time the router remains out-of-date after a network-changing event.

FIG. 4 illustrates an exemplary network node 400 for routing packets and reducing network convergence time for multiple sets of routing information. Network node 400 may correspond to one or more nodes A-G 110-170 in exemplary network 100. Network node 400 may include a packet receiver 405, link state advertisement identifier 410, routing processor 420, packet transmitter 425, forwarding table storage 430, link state database 440, shortest path tree generator 450, forwarding table generator 460, MPLS path generator 470, and MPLS path storage 480.

Packet receiver 405 may be an interface comprising hardware and/or executable instructions encoded on a machine-readable storage medium configured to receive packets from other network devices. Packet receiver 405 may include multiple ports and may receive packets from multiple network devices. For example, packet receiver 405 may receive link state advertisement packets and packets associated with regular network traffic.

Link state advertisement (LSA) identifier 410 may include hardware and/or executable instructions on a machine-readable storage medium configured to determine whether a received packet is an LSA that the node 400 should process. If the packet is an LSA, LSA identifier 410 may interpret the LSA and store the indicated network change in link state database 440 for further processing. Otherwise, LSA identifier may pass the packet to routing processor 420 for further routing.

It should be noted that, while various embodiments described herein relate to systems using link state advertisements constructed according to OSPF, various embodiments may work in conjunction with other standards using alternative network update messages. Accordingly, LSA identifier 410 may be viewed as a generic network update message identifier. Modifications useful for implementation in conjunction with such other standards will be apparent to those of skill in the art.

Routing processor 420 may include hardware and/or executable instructions on a machine-readable storage medium configured to route packets toward their destination. Routing processor 420 may extract a destination from each received packet and determine a next hop for that destination by using a forwarding table stored in forwarding table storage 430. Routing processor 420 may then forward the packet, via transmitter 425, to the appropriate next hop. Routing processor 420 may further be configured to process and forward MPLS packets according to routing information stored in MPLS path storage 480.

Packet transmitter 425 may be an interface comprising hardware and/or executable instructions encoded on a machine-readable storage medium configured to transmit packets to other network devices. Packet transmitter 425 may include multiple ports and may transmit multiple kinds of packets to multiple network devices. For example, packet transmitter 425 may transmit link state advertisement packets and packets associated with regular network traffic.

Forwarding table storage 430 may be any machine-readable medium capable of storing a forwarding table. Accordingly, forwarding table storage 430 may include a machine-readable storage medium such as read-only memory (ROM), random-access memory (RAM), magnetic disk storage media, optical storage media, flash-memory devices, and/or similar storage media.

Link state database (LSDB) 440 may be any machine-readable medium capable of storing a representation of the current network state. LSDB 440 may, for example, store an indication of every node and link within an autonomous system. Accordingly, LSDB 440 may include a machine-readable storage medium such as read-only memory (ROM), random-access memory (RAM), magnetic disk storage media, optical storage media, flash-memory devices, and/or similar storage media. LSDB 440 may be an independent storage device within node 400 or may be the same as forwarding table storage 430.

Shortest path tree (SPT) generator 450 may include hardware and/or executable instructions on a machine-readable storage medium configured to generate a shortest path tree from a representation of a network. For example, SPT generator 450 may use Djikstra's algorithm or any other method known to those of skill in the art to generate a shortest path tree from data stored in LSDB 440. After generating an SPT, SPT generator 450 may transmit the SPT to forwarding table generator 460. Alternatively, SPT generator 450 may transmit information to forwarding table generator 460 as each node is added to the SPT, allowing the forwarding table generator 460 to begin updating the forwarding table before the SPT is complete.

Forwarding table generator 460 may include hardware and/or executable instructions on a machine-readable storage medium configured to generate or update a forwarding table based on an SPT. For example, forwarding table generator 460 may determine whether any entries in forwarding table storage 430 should be added or modified based on the current SPT for the network node 400. Forwarding table generator 460 may then perform such updates by, for example, adding or removing entries or modifying the next hop of one or more entries.

Forwarding table generator 460 may be further adapted to prioritize the order of updating the forwarding table. For example, forwarding table generator 460 may deem entries associated with nodes that are within the autonomous system as critical and therefore perform updates to such entries first. Such entries may be identified according to any method known to those of skill in the art such as, for example, examining the SPT, using a list of router identifiers from whom LSAs are received, and/or searching for entries relating to a full 32-bit prefix. After completion of such critical updates, forwarding table generator 460 may inform MPLS path generator 470 that critical updates are completed. MPLS path generator 460 may then begin updating additional routing information, as will be described in further detail with reference to that component. During this time, forwarding table generator 460 may complete the non-critical updates to the forwarding table.

According to various alternative embodiments, forwarding table generator 460 may further prioritize critical updates. For example, forwarding table generator 460 may utilize the current SPT to identify neighbor nodes and update the corresponding forwarding table entries first. Forwarding table generator 460 may then move on to perform updates related to nodes that are two hops away. Forwarding table generator 460 may continue in this manner until all critical updates have been performed. After each such stage, forwarding table generator 460 may indicate to MPLS path generator 470 that some critical updates have been completed, allowing MPLS path generator 470 to begin updating the MPLS routing information.

According to additional alternative embodiments, forwarding table generator 460 may prioritize updates related to devices of particular types. For example, forwarding table generator 460 may process gateway routers to the autonomous system such as area border routers and/or area summary border routers, as soon as entries for immediate neighbors are updated. Forwarding table generator 460 may then move on to process remaining updates in a hop-by-hop fashion in an expanding wave.

It should be noted that, while node 400 is described as functioning according to various aspects of OSPF, the methods described herein may be applicable to other standards. Appropriate modifications for compliance with other standards will be apparent to those of skill in the art. Accordingly, SPT generator 450 and forwarding table generator 460 may be viewed, separately or together, as a generic “routing information generator.”

MPLS path generator 470 may include hardware and/or executable instructions on a machine-readable storage medium configured to generate or update MPLS routing information. MPLS path generator 470 may use information from forwarding table storage 430 to establish or modify the optimal MPLS paths and store such routing information in MPLS path storage 480. MPLS path generator 470 may be adapted to begin such update procedure after receiving an indication from forwarding table generator 460 that a network change has occurred and/or that at least some critical updates have been performed on the forwarding table.

It should be noted that, while node 400 is described as functioning according to various aspects of MPLS, the methods described herein may be applicable to other standards. Appropriate modifications for compliance with other standards will be apparent to those of skill in the art. For example, MPLS path generator 470 may be replaced by an L2TP path generator (not shown) that generates paths according to L2TP. Accordingly, MPLS path generator 470 may be viewed as a second generic “routing information generator.”

MPLS path storage 480 may be any machine-readable medium capable of storing MPLS routing information. MPLS path storage 480 may, for example, store numerous records specifying incoming labels, outgoing labels, incoming interfaces, and/or outgoing interfaces. Accordingly, MPLS path storage 480 may include a machine-readable storage medium such as read-only memory (ROM), random-access memory (RAM), magnetic disk storage media, optical storage media, flash-memory devices, and/or similar storage media. MPLS path storage 480 may be an independent storage device within node 400 or may be the same as forwarding table storage 430 and/or LSDB 440.

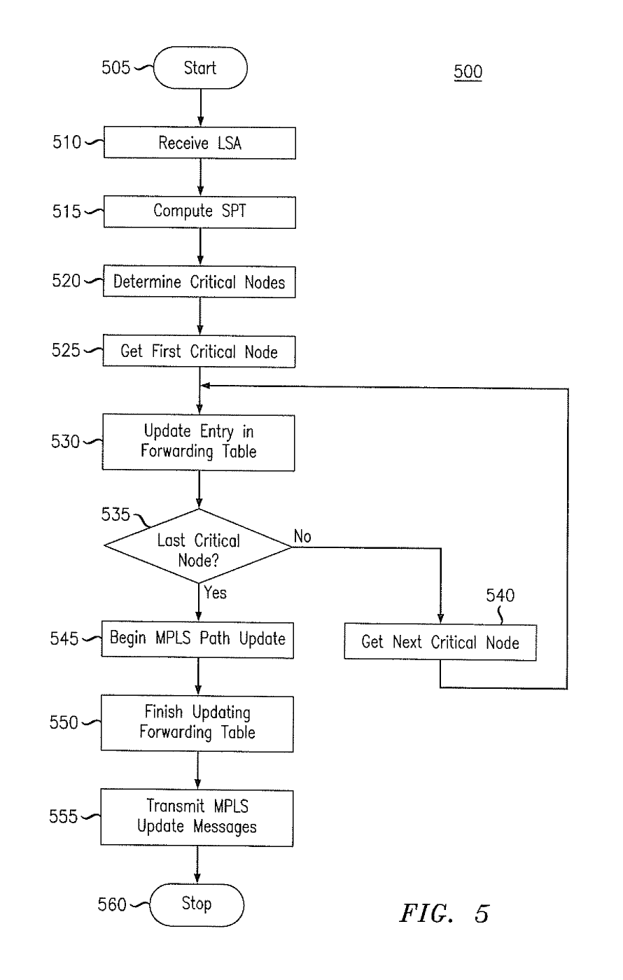

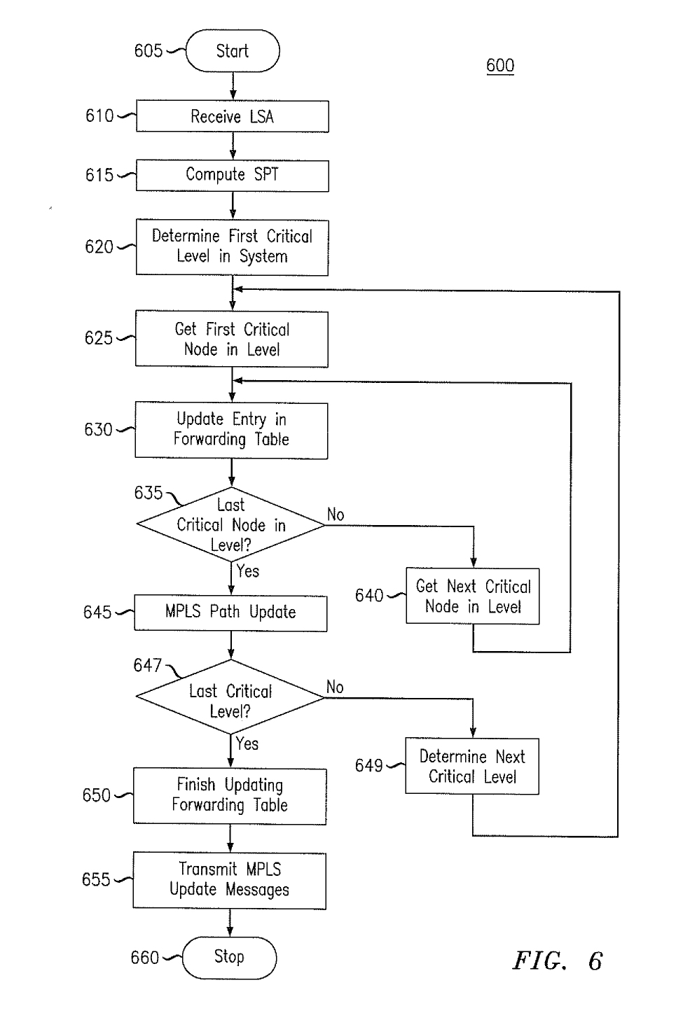

FIG. 5 illustrates an exemplary method 500 for reducing network convergence time for multiple sets of routing information. Method 500 may be performed by the various components of network node 400 such as, for example, LSA identifier 410, SPT generator 450, forwarding table generator 460, and/or MPLS path generator 470.

Method 500 may begin in step 505 and proceed to step 510 where node 400 may receive an LSA indicating a change in the network state. Node 400 may then compute a new SPT in step 515. Next, in step 520, node 400 may determine a list of critical nodes. For example, node 400 may determine that each node within an OSPF autonomous system is a critical node. Method 500 may then proceed to step 525, where node 400 may locate a first critical node to process.

In step 530, node 400 may update one or more entries associated with the critical node according to the newly computed SPT. For example, node 400 may locate an entry in the forwarding table including the 32-bit prefix address for the critical node and modify the next hop identification. Method 500 may then proceed to step 535 where node 400 may determine whether there are additional critical nodes to process. If there are, method 500 may proceed to step 540, where node 400 may locate the next critical node for processing, and loop back to step 530.

Once all critical nodes have been processed, method 500 may proceed to step 545, where node 545 may begin the process of updating MPLS routing information based on the forwarding table. Method 500 may proceed to step 550, where node 400 may finish updating the forwarding table by processing non-critical entries. It should be noted that this step may be performed at the same time, either in parallel on separate processors on by sharing processing time on a single processor, as the re-computation of the MPLS routing information. Either after or during the re-computation of the MPLS routing information, node 400 may transmit one or more MPLS update messages to other nodes, for example, according to the LDP or RSVP-TE protocols. Alternatively, node 400 may wait for the forwarding table update to complete before sending any MPLS update messages. Method 500 may then end in step 560.

FIG. 6 illustrates an alternative method 600 for reducing network convergence time for multiple sets of routing information. Method 600 may be performed by the various components of network node 400 such as, for example, LSA identifier 410, SPT generator 450, forwarding table generator 460, and/or MPLS path generator 470. Method 600 may be similar to method 500, while further prioritizing updates to the forwarding table.

Method 600 may begin in step 605 and, similar to method 500, receive an LSA and compute a new SPT in steps 610 and 615, respectively. In step 620, node 400 may determine a set of most critical nodes in the system. For example, node 400 may deem those nodes on the first level below the root of the SPT to be most critical. These nodes may be referred to as neighbor nodes. Method 600 may then proceed to step 625 where node 400 may determine a first node to process from this set of most critical nodes.

In step 630, similar to step 530 in method 500, node 400 may update one or more entries associated with the critical node in view of the new SPT. Method 600 may then proceed to step 635 where node 400 may determine whether there are additional critical nodes to process in the current level. If there are, node 400 may locate the next critical node in the current level in step 640 and method 600 may loop back to step 630.

Once all critical nodes within a level have been processed, method 600 may proceed to step 645, where node 400 may perform at least a portion of the update procedure for MPLS routing information based on the recent updates to the forwarding table. As this process is performed, method 600 may proceed to step 647, where node 400 may determine whether additional critical levels remain to be processed. If so, method 600 may proceed to step 649, where node 600 may retrieve the next group of critical nodes. For example, node 400 may retrieve the group of nodes on the next level down on the SPT from the most recently processed level. In this manner, node 400 may sequentially process the “one hop,” “two hop,” and so on nodes. Method 600 may then loop back to step 625 to process the new critical level.

Once all critical updates have been performed, method 600 may proceed to step 650. As in method 500, node may finish updating the forwarding table by processing all non-critical updates. Node 400 may then transmit one or more MPLS update messages in step 655 and method 600 may end in step 660.

According to the foregoing discussion, various exemplary embodiments enable reduction of network convergence time. In particular, by selectively updating certain routing information first and triggering a secondary routing information generator, a network node can reduce the time it takes for all nodes in the network to converge to a common routing state.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

The functions of the various elements shown in the FIGs., including any functional blocks labeled as “processors”, may be provided through the use of dedicated hardware as well as hardware capable of executing processing steps in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method of reducing update time for routing information in a network performed by a network node, the method comprising:
receiving, at the node, a network state update message;
updating a first portion of a first set of routing information based on the network state update message;
after updating the first portion of the first set of routing information, beginning an update of a second set of routing information; and
after beginning the update of the second set of routing information, updating a second portion of the first set of routing information.

2. The method of claim 1, further comprising after beginning the update of the second set of routing information, updating the second set of routing information based on the first portion of the first set of routing information.

3. The method of claim 1, wherein the step of updating the first portion of the first set of routing information comprises:
determining at least one other node within the network for which routing information should be used to update the second set of routing information; and
updating routing information associated with the at least one other node in the first set of routing information.

4. The method of claim 1, wherein the first portion of the first set of routing information includes only routing information corresponding to other nodes within an autonomous routing system to which the node belongs.

5. The method of claim 1, wherein the first portion of the first set of routing information includes only routing information corresponding to neighbor nodes of the node and the second portion of the first set of routing information includes only routing information corresponding to nodes that are two hops away from the node, the method further comprising:
after updating the second portion of the first set of routing information, beginning a second update of a second set of routing information; and
after beginning the second update of the second set of routing information, updating a third portion of the first set of routing information.

6. The method of claim 1, wherein at least one of the first portion and the second portion includes only routing information corresponding to nodes that are a particular type of device.

7. The method of claim 1, further comprising:
after at least a portion of the second set of routing information is updated, constructing a routing information update message based on the second set of routing information; and
transmitting the routing information update message to at least one other node.

8. The method of claim 1, wherein the first set of routing information includes IP routing information and the second set of routing information includes at least one of: MPLS path information and Layer 2 Tunneling Protocol (L2TP) path information.

9. A network node for reducing update time for routing information in a network, the network node comprising:
a first interface that receives a packet from another node;
a network state update message identifier that determines that the packet is a network state update message;
a first routing information storage that stores a first set of routing information;
a second routing information storage that stores a second set of routing information;
a first routing information generator that:
updates a first portion of the first set of routing information based on the network state update message,
after updating the first portion, indicates that the first portion has been updated, and
after indicating that the first portion has been updated, updates a second portion of the first set of routing information based on the network state update message; and
a second routing information generator that, in response to the indication that the first portion has been updated, updates the second routing information based on the first portion of the first set of routing information.

10. The network node of claim 9, wherein, in updating the first portion of the first set of routing information, the first routing information generator further:
determines at least one critical node in the network, wherein routing information associated with the at least one critical node will be used to update the second set of routing information; and
updates routing information associated with the at least one critical node in the first set of routing information.

11. The network node of claim 9, wherein the first portion of the first set of routing information includes only routing information corresponding to other nodes within an autonomous routing system to which the node belongs.

12. The network node of claim 9, wherein:
the first portion of the first set of routing information includes only routing information corresponding to neighbor nodes of the node;
the second portion of the first set of routing information includes only routing information corresponding to nodes that are two hops away from the node;
the first routing information generator further:
after updating the second portion of the first set of routing information, indicates that the second portion has been updated, and
after indicating that the second portion has been updated, updates a third portion of the first set of routing information based on the network state update message; and
the second routing information generator further, in response to the indication that the second portion has been updated, updates the second routing information based on the second portion of the first set of routing information.

13. The network node of claim 9, wherein at least one of the first portion and the second portion includes only routing information corresponding to nodes that are a particular type of device.

14. The network node of claim 9, further comprising a second interface that transmits packets to other nodes, wherein the second routing information generator further:
after updating at least a portion of the second set of routing information, constructs a routing information update message based on the second set of routing information, and
transmits the routing information update message to at least one other node via the second interface.

15. The network node of claim 9, wherein the first set of routing information includes IP routing information and the second set of routing information includes at least one of: MPLS path information and Layer 2 Tunneling Protocol (L2TP) path information.

16. A machine-readable storage medium encoded with instructions for execution at a network node for reducing update time for routing information in a network, the machine-readable storage medium comprising:
instructions for receiving, at the node, a network state update message;
instructions for updating a first portion of a first set of routing information based on the network state update message;
instructions for, after updating the first portion of the first set of routing information, beginning an update of a second set of routing information; and
instructions for, after beginning the update of the second set of routing information, updating a second portion of the first set of routing information.

17. The machine-readable storage medium of claim 16, further comprising instructions for, after beginning the update of the second set of routing information, updating the second set of routing information based on the first portion of the first set of routing information.

18. The machine-readable storage medium of claim 16, wherein the instructions for updating the first portion of the first set of routing information comprise:
instructions for determining at least one other node within the network for which routing information should be used to update the second set of routing information; and
instructions for updating routing information associated with the at least one other node in the first set of routing information.

19. The machine-readable storage medium of claim 16, wherein the first portion of the first set of routing information includes only routing information corresponding to other nodes within an autonomous routing system to which the node belongs.

20. The machine-readable storage medium of claim 16, wherein the first portion of the first set of routing information includes only routing information corresponding to neighbor nodes of the node and the second portion of the first set of routing information includes only routing information corresponding to nodes that are two hops away from the node, the machine-readable storage medium further comprising:
instructions for, after updating the second portion of the first set of routing information, beginning a second update of a second set of routing information; and
instructions for, after beginning the second update of the second set of routing information, updating a third portion of the first set of routing information.

21. The machine-readable storage medium of claim 16, wherein at least one of the first portion and the second portion includes only routing information corresponding to nodes that are a particular type of device.

22. The machine-readable storage medium of claim 16, further comprising:
instructions for, after at least a portion of the second set of routing information is updated, constructing a routing information update message based on the second set of routing information; and
instructions for transmitting the routing information update message to at least one other node.

23. The machine-readable storage medium of claim 16, wherein the first set of routing information includes IP routing information and the second set of routing information includes at least one of: MPLS path information and Layer 2 Tunneling Protocol (L2TP) path information.
